(19) United States
(12) Patent Application Publication
(10) Pub. No.: US 2009/0193085 A1
(43) Pub. Date: Jul. 30, 2009

(54) Patient informational exchange

(76) Inventor: E. Harvey Estes, Durham, NC (US)

Correspondence Address: OLIVE & OLIVE, P.A., 500 MEMORIAL STREET, PO BOX 2049, DURHAM, NC, 27702, US

(21) Appl. No.: 12/011,679

(22) Filed: Jan. 29, 2008

(51) Int. Cl. G06F 15/16

(52) U.S. Cl. 709/206

(57) ABSTRACT

Described herein are systems and methods for patients to exchange information related to medical conditions and systems and methods to provide a discussion forum by which patients may converse by posting and reviewing electronic messages. The stored messages may be indexed and moderated by a medical expert. The content of the messages may be mined for useful information, such as to identify a new treatment or syndrome or reaction to a drug.

### BACKGROUND

The invention relates to an online discussion forum where patients can share information and experiences associated with a medical condition, symptom, syndrome, or responses to drugs or other medical treatments. Free flow conversation among those actually living with medical conditions themselves, or caring for those who are, allows the patients to express their role in their diagnoses and to discuss the successful or unsuccessful status of their medical treatment. Valuable information regarding new treatments, side effects, or syndromes can be gleaned from observations reported among patients.

The Internet currently allows access to a vast store of information about illnesses and their treatments. There are many websites sponsored by medical organizations. They allow the user to gain access to authoritative definitions and information on signs, symptoms, treatments, complications, and more concerning medical conditions. Some websites offer medical consultation in the form of on-line chat. Other websites are informal personal “chat lines” or exchanges, part of the social networking phenomenon. This second group permits the user to contact other users who may have a similar symptom, syndrome, or diagnosis in order to exchange information and experiences. The content of the information shared varies widely, and ranges from encouragement and support, to specific advice for foods, behavior, home remedies, treatments, etc. that are shared between individuals with similar problems and their families and caregivers. These informal exchanges have proved to be helpful to many users. However, chat lines may be critical of traditional medical approaches and treatments, and can become an outlet for frustration and anger directed at medicine and its practitioners. They also can be an outlet for those who are deluded or suffering from significant mental illness. Some promote the activities of those who pretend to be experts, or advocate treatments that might be dangerous to users. Chatroom users have even been known to pretend to be patients and pass on contrived information as if it were from their own experience (Feldman, Western Jo Medicine 168: 537-539 (1998)).

More and more patients are seeking medical advice in chat rooms and the like. However, credible sources can be hard to discern. By exposing the user to incorrect or dangerous suggestions, informal social networking exchanges have the potential to be harmful. In a study by Culver, Gerr, and Frumkin (Jo General Internal Med 12(8): 466-70 (1997)), the investigators found that only 5.3% of the messages were authored by health care providers, only 0.3% by physicians, and that one-third of the messages posted on a medical electronic bulletin board were inconsistent with conventional medical practices. Furthermore, the user communications do not always relate to a medical problem. Many forums that superficially appear to be directed to health issue or health conditions appear on closer examination to be purely social exchanges, often focusing on personal news, pets, family, and the like.

Some other online medical information exchanges that exist are not currently made available directly to patients. The social networking site named Sermo™ (sermo.com), for example, is believed to be the largest online physician community in the United States. That website provides, among other things, an information exchange (the Sermo™ forum), that focuses on strategies for treating difficult or unusual patient problems. The Sermo™ forum is open only to experts, namely physicians practicing in the United States. In the Sermo™ forum, doctors can discuss traditional therapeutic methods, as applied to rare or complex clinical situations. The dialogue relating to these issues generally is highly technical and typically geared toward traditional science.

Forums like Sermo™ that attempt to share learning among members and thereby improve health treatment and outcomes, but limit participation to experts, overlook the reality that those who suffer from illnesses or diseases have a great deal of practical wisdom and information about their condition, its treatment, and its impact on their bodies and lives. This type of information is not the same as that which is captured in conventional medical information sources and formal provider sources.

Beyond the obvious support that can be found in sharing experiences with others with similar problems, the accumulated information in these informal chat lines can have therapeutic value and relevance. As an example, the inventor is aware of a 53 year old man who underwent a surgical removal of a large carcinoma of the rectosigmoid colon, with diversion of the intestinal contents via an ileostomy for a period of about one year while undergoing chemotherapy and radiation treatment to the area. Following the restoration of colon continuity, he experienced frequent small bowel movements, cramps, and poor bowel control preventing him from resuming work or normal activities of living. His surgeon and oncologist had no suggestions for management. His wife found a patient information exchange site that allowed her to consult with patients and caregivers who had experienced a similar sequence of events. A caregiver provided the insight that the colon in such cases, deprived of normal use for a year, required retraining, such as might occur in an infant or a new puppy. She counseled the wife and provided useful advice as her husband's colon was “retrained”. Five years later, he has returned to full function and employment, with only occasional minor flares of his symptoms. As this example illustrates, these informal networks clearly have the potential to be, and can be, useful to those who find appropriate advice or support from others sharing the same problems. Patient chat also may be informative not only in identifying what treatments work, but also which ones fail. Yet these types of useful information, gleaned from patient exchanges, may be unknown to or ignored by medical professionals who do not have the time or inclination to monitor the content.

Much of the information in these informal sources is repetitive, or well known to medical professionals (either as accurate or as inaccurate) and the inventor believes that this contributes to a disinclination on the part of many professionals to spend substantial time reviewing these sources. However, occasional nuggets of valuable information, worthy of further scientific inquiry or testing, can be identified. These nuggets of information need to be harnessed by medical professionals. A patient information exchange would be more valuable if it were systematically filtered for such nuggets of useful information.

The present inventor overcomes the above mentioned and other problems of the prior art by beginning with the premise that the medical and related health professions do not know all that can be known, and that the individual patient and other nonprofessionals who interact with patients and their care can contribute significant new knowledge, of value to themselves, to others with similar illnesses, and to the medical profession.

What is needed is an information exchange (referred to in shorthand fashion as a “patient information exchange” although participants are not limited to patients) that provides a link with health professionals and the large body of science-based knowledge, but also allows and encourages users to observe, share, and compare experiences with others, supported in the background by a medical expert who would monitor the information exchange and is able to post a cautionary or informative message to the forum, for example, educating the participants through links to information that the expert deems to be reliable. Also needed is an expert who is charged with identifying observations and suggestions from users that might offer help to a wider group of patients, or that might be enhanced by further confirmation and/or evaluation. The system and corresponding methods described herein are an effective solution to the above-mentioned difficulties of the prior art.

### SUMMARY

The present invention is directed to a novel information exchange system and method wherein patients share information about their medical conditions and treatments. Various embodiments of the system are presented. The system may be professionally indexed so that the potential user can find content focused to his or her needs. The system may be monitored by one or more knowledgeable medical experts who can insert links to additional sources or cautionary and/or clarifying content. The monitor may permit the free exchange of comment between users, while alerting participants to possibly dangerous or false information. The messages exchanged among users may be systematically mined for useful information, such as previously unrecognized effective treatments, adverse reactions to drugs, constellations of symptoms or signs that would identify new medical syndromes, unusual symptoms whose meaning is currently unknown, and quality control information for the sponsoring institution.

### DETAILED DESCRIPTION

The patient information exchange described herein provides an exchange system between patients or their caregivers wherein users of the system share observations about responses to medications, procedures, medical advice, and about treatments that they have discovered, often outside professional channels, to be helpful in “feeling better.”

In contrast to medical information exchanges that are highly technical and based on traditional science, conveying to users information that has been developed as a result of scientific research, professional training, and/or professional experience, the information exchange described herein is highly personal, based on the experiences and observations of the users. That is, the information exchanged is based on self-examination and observation. It is premised on the idea that the individual can and should be an active and equal partner with health professionals in his or her own health care, and that the patient's observations and evaluations are extremely important in the overall prevention, treatment, and outcome of illness. This is in contrast to much of the current literature which criticizes lay medical exchanges as lacking information authored by health professionals. The inventive patient information exchange recognizes that patients themselves can contribute valuable observations, sometimes even unknowingly, about their health and treatment.

The instant patient information exchange is a system wherein a community of patient users may share information related to their medical conditions. The system comprises an online discussion forum, a moderator of the forum, an index, and a data-miner that mines the users' communications for information useful to the medical field. The invention additionally includes a method of operating a system to share information among a community of patient users and to identify potential medical advances by providing said online discussion forum, moderator, index, and data-miner.

Patients, or their caretakers, collectively referred to as “patients” and including human or other animal patients, generate conversation in the forum for online discussion by posting electronic messages to the forum via a posting routine. The patients discuss issues related to their health care such as a symptom, syndrome, diagnosis, or adverse drug reaction. Their messages are posted to a server. The server may utilize the Internet or a wide area network but need not do so. The term “server” is intended to broadly encompass any server to or through which messages may be communicated. A storage routine stores the messages to the server. Each message comprises at least one word, image, or sound submitted by an author. The discussion may be in the form of synchronous or asynchronous communication, i.e. the discussions may take place essentially in “real time” with exchanges that are substantially simultaneous as is a normal conversation, or may take place over a longer period with a lapse in time between a submission by an author and a submission by a respondent. The discussion forum may be a chat room, newsgroup, mailing list, electronic bulletin board, blog, wiki or other exchange of messages such as email or instant messages.

The moderator of the exchange preferably would be a medical expert who monitors the messages exchanged in the forum. The moderator may post cautionary or informative messages to the forum. The invention includes embodiments where the medical expert is a person qualified by training or experience to diagnose, treat, or conduct research pertinent to at least one aspect of human or other animal health or wellness. This includes but is not limited to persons having degrees such as MD, DO, DDS, PhD, DVM, etc.

The present patient information exchange system provides information and education to the user with an emphasis on the exchange of observations about responses to a specific illness or condition, between individuals who suffer from or are caring for those with a similar problem. Though the expert moderator can insert informational links which might prove useful, a primary emphasis is on users sharing their mutual experiences, and at the same time, through use of this system, informing the traditional provider community, about problems, useful techniques, etc.

The information posted by the moderator may be in the form of a link to additional information available on the Internet. In one embodiment, the information exchange would provide additional information in a sidebar format which would provide an added level of information and safety, without impeding the flow of information from person to person.

The messages and information posted to the discussion forum are indexed. The index comprises a text indexing server capable of indexing the messages based on keywords or phrases. Patient conversations are sorted into topics, preferably under the supervision of a medical expert. A user of the information exchange system may select one or more electronic messages, preferably by using a topic parameter but alternatively by free text searching. The user makes a query, a request for information about a topic of interest. The text indexing server is capable of receiving the user query, determining whether any electronic messages exist in response to the query, and retrieving at least a portion of such responsive message(s) or information about them, if any responsive messages exist. The text indexing server then transmits the responsive message(s) or information concerning the message(s) in a form reviewable by the user. In many instances users will want to read the messages themselves but may also prefer statistical information about them such as, for example, the number of messages containing the phrase “prostate cancer” or “gin-soaked raisins.” In one embodiment, the posting routine is capable of executing within a web browser program and the user receives query results via the web browser on a personal computer.

The exchange is useful to those seeking information because the comprehensive, continually updated index can quickly guide the user to the most relevant and useful threads. There may also be sections in the index for those whose symptoms do not fit a currently recognized medical diagnosis. Finding significant numbers of individuals with the same constellation of symptoms could lead to the recognition of common underlying factors or a new syndrome. And even in the absence of such an outcome, patients will get support and benefit from sharing common experiences and observations, which also has a positive therapeutic effect.

A fourth element of the patient information exchange system is the data-miner (which is not necessarily itself a user and need not even be human) that is capable of analyzing the users' electronic communications so that features of interest related to a health condition or symptom may be identified. Data mining is the process of sorting through large amounts of data, such as the text of electronic messages, and picking out relevant information to discover patterns and relationships within the data source. The data-miner described herein searches for features of interest such as information indicative of a new treatment, a constellation of symptoms of a new medical syndrome, or an unusual symptom whose meaning is currently unknown. It may also search for an adverse reaction, new indication, or contraindication of a drug. It may also search for an interaction between two drugs or a relationship between a chemical compound or biomolecule and a disease.

In the simplest form, the data-miner could be a person trained to recognize relevant information such as associations between medical conditions, treatments, drugs, symptoms, and diseases. But a data-miner with greater utility would analyze the message text using a computer-assisted data processing algorithm wherein the data processing algorithm generates a result data set comprising features of interest. The data-miner may operate on “raw” data from the electronic messages, as well as on filtered or otherwise processed data from the message archive.

In one embodiment, the data processing algorithm employs a knowledge discovery routine capable of identifying relationships between objects based on logical associations. The knowledge discovery routine identifies one or more co-occurrences of objects, an object being an instance of a class, within the stored messages generated in the discussion forum. The knowledge discovery routine further identifies at least one relationship between the objects. The relationship(s) is stored in a database of the information exchange system. The system further includes a query module that allows the researcher to access information about the relationship(s).

Part of the value of the present system is that it can provide an exchange, between those who are enduring illness and sharing their experiences, wherein the conversation posted to the discussion is not censored for medical content. In traditional medical information exchanges, there is a risk that insertion of medical professionals into the discussion forum can alter or stifle free exchange and legitimate criticism of medical practices. In the present invention, this risk can be minimized by making it clear to users that the moderator is permitted to insert a warning or clarifying information, but cannot otherwise interfere with the free and spontaneous exchange between individual participants. The invention does include an embodiment wherein the system employs a filter that prevents communications from being displayed that contain profane language or commercial advertising. The invention further includes embodiments where the moderator may censor a message for repetitive or abusive content.

In addition to or instead of inserting warnings and relevant information into a conversation thread or, for example, on a sidebar as discussed above, the monitor may attempt to accomplish additional or other objectives. The monitor may improve and sharpen the exchange by overseeing the organization and continuous revision and expansion of the index, thus making the index more accessible and relevant. The monitor may also identify information of possible benefit to patients, for further formal study or for bringing to the attention of the medical profession. Furthermore, the monitor may identify criticism or suggestions directed at the health care system, or its practitioners, which, if improved or corrected, could benefit patients and the health care system. The monitor may identify content that might be a “first alert” to an emerging new medical diagnosis, a reaction to a new drug, or a new complication of medical treatment, and alert appropriate authorities. Thus, the monitor can endeavor to make the discussion forum a more effective support system for the patient or caregiver user, and a more effective informational source for medical and health professionals.

The patient users of the instant system and method may be associated with a major medical facility. Therefore, in another embodiment, the patient information exchange is sponsored and supported by a recognized and reputable medical organization. This organization provides a professionally designed index for the discussion forum, enabling the prospective user to find an appropriate and relevant thread. The organization would also provide expert monitors, who regularly read the content of threads relating to their areas of expertise.

The organization sponsoring the proposed discussion forum will ideally have certain capabilities that will maximize the benefits that can be derived from the patient information exchange. For example, the organization ideally would have a sufficient number and variety of medical professionals to monitor threads on a variety of subjects in a prompt and informed manner. A medical center or a general medical professional organization with a number of medical specialties represented in its staff or membership could provide these skills.

Preferably, such an organization would be willing to assume the responsibility for prompt and objective response in case a warning is needed, but also would be willing to let a thread run if no reader danger is involved, even though the exchange might be critical of the medical profession, the organization, or its staff. Preferably, the organization would provide monitors who can identify authoritative sources for informational or cautionary insertions, using the most appropriate and current information and links available. For liability purposes, a disclaimer stating that the site is not providing medical care (unless the site elects to provide such care and provides an appropriate capability for doing so), should also be provided to the reader. Preferably, the sponsoring organization would also be able to identify organizations and offices that should be informed of trends or information important to the medical profession or to public health, and to identify, publicize, or act upon information from the exchange which might deserve further study, or which might indicate a new syndrome or a new side effect/reaction to a drug.

Moreover, the organization may need to accept that the exchange might provide a source of support, to those suffering from certain illnesses, that might substitute for or supplant their own medical staff in certain cases, thus decreasing their revenue stream.

In another embodiment, access to the information exchange system is controlled and use of the system is limited to those who register by providing their name, e-mail address, and street address; or other appropriate identifying information. Where anonymity is desired, which is typical in medical settings, each user could then choose a code name to be used in subsequent exchanges. In such a setting, the sponsoring institution typically would agree not to disclose personal information and/or the identifying information, or not to publicly associate particular exchanges with the true identity of the persons who participated in the communication. The invention includes an embodiment where the users of the information exchange are identified by code names.

In another embodiment, each user, before gaining access, would be required to read and accept a general disclaimer. The disclaimer would include one or more of the following: a statement that the exchange is not for purposes of medical treatment, or a substitute for a personal physician; an agreement that the sponsor is not liable for injury or adverse affects sustained as a result of following advice gained from the exchange; and an agreement that the user can be excluded from use of the exchange for attempted commercial exploitation, for abusive or indecent language, or for repetitive or inappropriate submissions.

For the patient user, the present invention provides ready access to others who have experienced similar illnesses or complaints, and who in turn can provide sympathy, empathy, and support. It provides useful suggestions about the management or treatment of illness, and cautionary information about harmful or useless advice. In addition, this information exchange provides information for those who are reticent to admit that they do not understand professional instructions or advice, but who are willing to share with others on a less formal basis. Preferably, the system would provide these benefits to the patient users without cost to these users.

For practical start-up and implementation of the exchange, an informational brochure can be given to each patient who visits a sponsoring medical center. The brochure would outline the nature of the exchange and invite patients and their supporting individuals to participate. Each patient would be invited to tell others about the exchange.

For maximal benefit for the user, health professionals, and society, this service should be operated as a public service to patients, with care to prevent intrusive or flagrant commercial exploitation in the form of advertising. The principle reward for the sponsoring organization is in the fact that it provides a useful service to patients, both those utilizing their own medical services and those utilizing other medical providers.

The system is not only beneficial to the patients but also to the sponsoring institution and medical field in general. For the sponsoring institution, the system provides a means of promoting the health and wellbeing of its patients. It provides a means for patients to augment and clarify the advice given by physicians and other professionals, and to become involved as responsible partners in their own care. It promotes an image of institutional concern and caring for patients and brings the name and reputation of the institution to the attention of a wider area and number of patients. The information exchange provides the institution with a new and powerful tool for patient care. Use of the system places the institution in a position to partner with the pharmaceutical industry and government agencies that need access to non-patient-specific information that can be gleaned from the exchange.

The system can improve patient care by calling to professional attention useful therapeutic suggestions from users of the exchange. It can provide a type of internal quality control about the institution and medical care generally, supplementing the usual questionnaires and surveys, at minimal cost. The system provides a way to utilize the significant knowledge and experience of staff experts who could serve as monitors for the system, especially medical staff who are at or nearing retirement age and may customarily be barred from surgery, for example. Use of the system would increase and improve the interactions and cohesion among the medical staff, through review and discussion of information obtained through the exchange. The system would provide to the medical and other professional staff direct exposure to problems and concerns of their collective patient base.

The patient information exchange system could also generate external funds to support itself, and more. Partnerships with pharmaceutical companies and government agencies could generate financial support in exchange for access to information. Potential sources of support include appropriate spot advertisements for over the counter and prescription drugs and devices, pharmaceutical companies needing objective information about responses to their products, agencies such as the Food and Drug Administration interested in early warnings about adverse reactions, researchers wanting access to the database to study the user population, etc.

Additional revenues could be generated by licensing the system to other organizations that wish to provide such a service in other areas of the country or in other countries. Agreements to license the use of the system may include an agreement to share mined information about adverse reactions, new syndromes, etc. By gaining access to mined information from these licensees, the sponsoring institution can multiply the public and professional benefit of the system.

The invention in its broader aspects is not limited to the specific details described herein. Departures may be made from such details without departing from the principles of the invention and without sacrificing its chief advantages.

1) A system for sharing information related to medical conditions among a community of patient users, the system comprising:
a) a forum for online discussion in which conversation among patients or their caretakers is generated in the form of one or more electronic messages relating to a topic, the forum comprising:
i) a posting routine capable of generating messages from said users that can be posted to a server; and
ii) a storage routine for storing messages from said users on the server;
wherein the discussion is in the form of synchronous or asynchronous communication; and
wherein a message comprises at least one word, image, or sound submitted by an author;
b) a moderator of the online forum, wherein the moderator is a medical expert who monitors the forum and is able to post a cautionary or informative message to the forum;
c) an index, wherein a user is able to select at least one of the electronic patient messages using a topic parameter, said index comprising a text indexing server operable to index the messages based on keywords or phrases contained in the messages, wherein the text indexing server is operable to:
i) receive a user query, said query being a request for information about a topic of interest;
ii) determine whether there exists one or more electronic message(s) responsive to said user query; and
iii) if a responsive message(s) exists, retrieve at least a portion of the responsive message(s) or information concerning the message(s) and transmit at least a portion of the retrieved message(s) or information to the user in response to the query such that the transmitted message(s) or information is reviewable by the user;
wherein the sorting of patient conversations into topics is supervised by a medical expert; and
d) a data-miner which analyzes the users' electronic communications in order to identify a feature of interest related to a health condition or symptom.

2) A method of operating a system to share information among a community of patient users and to identify potential medical advances comprising:
a) providing a forum for online discussion in which conversation among patients or their caretakers is generated in the form of one or more electronic messages relating to a topic, the forum comprising:
i) a posting routine capable of generating messages from said users that can be posted to a server; and
ii) a storage routine for storing messages from said users on the server;
wherein the discussion may be in the form of synchronous or asynchronous communication; and
wherein a message comprises at least one word, image or sound written by an author;
b) providing a moderator of the online forum, wherein the moderator is a medical expert who monitors the forum and is able to post a cautionary or informative message to the forum;
c) providing an index, wherein a user may select at least one of the electronic patient messages using a topic parameter, said index comprising a text indexing server operable to index the messages based on keywords or phrases contained in the messages, wherein the text indexing server is operable to:
i) receive a user query, said query being a request for information about a topic of interest;
ii) determine whether there exists one or more electronic message(s) in responsive to said user query; and
iii) if a responsive message(s) exists, retrieve at least a portion of the responsive message(s) or information concerning the message(s) and transmit at least a portion of the retrieved message(s) or information to the user in response to the query such that the transmitted message(s) or information is reviewable by the user;
wherein the sorting of patient conversations into topics is supervised by a medical expert; and
d) providing a data-miner which analyzes the users' electronic communications in order to identify a feature of interest related to a health condition or symptom.

3) The system of claim 1 wherein the forum in step a) is a chat room, newsgroup, mailing list, electronic bulletin board, blog, wiki or an exchange of instant messages or email.

4) The system of claim 1 wherein the content provided by the expert in step b) comprises a link to an article of additional information available on the internet.

5) The system of claim 1 wherein the information mined by the data-miner in step d) is indicative of:
a) a previously unrecognized treatment;
b) an adverse reaction, new indication, or contraindication of a drug;
c) an interaction between two drugs;
d) a relationship between a chemical compound or biomolecule and a disease;
e) a constellation of symptoms of a new medical syndrome; or
f) an unusual symptom whose meaning is currently unknown.

6) The system of claim 1 wherein the data-miner analyzes the message text by applying a computer-assisted data processing algorithm to generate a result data set of features of interest.

7) The system of claim 6 wherein the data processing algorithm employs a knowledge discovery routine capable of identifying relationships between two or more objects based on logical associations, wherein the knowledge discovery routine identifies one or more co-occurrences of objects within the electronic message data source and identifies at least one relationship between the objects, wherein the at least one relationship identified is stored in a system database and the system further includes a query module that allows a researcher to access information about the at least one relationship.

8) The system of claim 1 further comprising a filter that prevents a communication from being displayed when the communication contains profane language or commercial advertising.

9) The system of claim 1 wherein the discussion forum is not censored for medical content.

10) The system of claim 1 wherein the patients discuss a symptom, syndrome, diagnosis, or response to a drug or medical treatment.

11) The system of claim 1 wherein the moderator is a person qualified by training or experience to diagnose, treat, or conduct research pertinent to at least one aspect of human or other animal health or wellness.

12) The system of claim 1 wherein the patient users are associated with a major medical facility.

13) The system of claim 2 wherein the forum in step a) is a chat room, newsgroup, mailing list, electronic bulletin board, blog, wiki or an exchange of instant messages or email.

14) The system of claim 2 wherein the content provided by the expert in step b) comprises a link to an article of additional information available on the internet.

15) The system of claim 2 wherein the information mined by the data-miner in step d) is indicative of:
a) a previously unrecognized treatment;
b) an adverse reaction, new indication, or contraindication of a drug;
c) an interaction between two drugs;
d) a relationship between a chemical compound or biomolecule and a disease;
e) a constellation of symptoms of a new medical syndrome; or
f) an unusual symptom whose meaning is currently unknown.

16) The system of claim 2 wherein the data-miner analyzes the message text by applying a computer-assisted data processing algorithm to generate a result data set of features of interest.

17) The system of claim 16 wherein the data processing algorithm employs a knowledge discovery routine capable of identifying relationships between two or more objects based on logical associations, wherein the knowledge discovery routine identifies one or more co-occurrences of objects within the electronic message data source and identifies at least one relationship between the objects, wherein the at least one relationship identified is stored in a system database and the system further includes a query module that allows a researcher to access information about the at least one relationship.

18) The system of claim 2 further comprising a filter that prevents a communication from being displayed when the communication contains profane language or commercial advertising.

19) The system of claim 2 wherein the discussion forum is not censored for medical content.

20) The system of claim 2 wherein the patients discuss a symptom, syndrome, diagnosis, or response to a drug or medical treatment.

21) The system of claim 2 wherein the moderator is a person qualified by training or experience to diagnose, treat, or conduct research pertinent to at least one aspect of human or other animal health or wellness.

22) The system of claim 2 wherein the patient users are associated with a major medical facility.
